(19) United States
(12) Patent Application Publication
(10) Pub. No.: US 2009/0204399 A1
(43) Pub. Date: Aug. 13, 2009

(54) SPEECH DATA SUMMARIZING AND REPRODUCING APPARATUS, SPEECH DATA SUMMARIZING AND REPRODUCING METHOD, AND SPEECH DATA SUMMARIZING AND REPRODUCING PROGRAM

(75) Inventor: Susumu Akamine, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 12/301,201

(22) PCT Filed: May 7, 2007
(86) PCT No.: PCT/JP2007/059461

§ 371 Date: Nov. 17, 2008

(30) Foreign Application Priority Data
May 17, 2006 (JP) 2006-137508

(51) Int. Cl. G10L 15/00; G10L 15/26

(52) U.S. Cl. 704/235; 704/231; 704/E15.014; 704/E15.045

(57) ABSTRACT

Necessary portions of stored speech data representing conference content are summarized and reproduced in a predetermined time. Conference speech is summarized and reproduced using a speech data summarizing and reproducing apparatus comprising a speech data divider for dividing and structuring conference speech data into several utterance unit data based on utterers, distributed documents, the occurrence frequency of words in speech recognition results, and pauses, an importance level calculator for determining important utterance unit data based on the occurrence frequency of keywords, the information of utterers, and data specified by the user, a summarizer for extracting important utterance unit data and summarizing them within a specified time, and a speech data reproducer for reproducing the summarized speech data in chronological order or an order of importance levels with auxiliary information added thereto.

### TECHNICAL FIELD

The present invention relates to a speech data summarizing and reproducing apparatus, a speech data summarizing and reproducing method, and a speech data summarizing and reproducing program for extracting only necessary data from a speech archive which has recorded or stored lectures and conferences and for summarizing and reproducing the extracted data.

### BACKGROUND ART

Heretofore, when the contents of lectures and conferences are to be referred to and confirmed, there has been used a method of playing back a tape which has stored the contents of a conference, or a method of producing and referring to conference minutes. According to the method which uses a recording tape, the recording tape is fast-forwarded or rewound to skip unnecessary data, and played back to reproduce speech data to confirm the contents of a conference.

According to the method of producing and referring to conference minutes, it has been customary for the conference participants to produce conference minutes by recording the contents of the conference. However, this method imposes a lot of burdens on the writers. Japanese patent No. 3185505 discloses a conference minute production assisting apparatus for assisting the production of conference minutes based on the contents of the conference which have been recorded. The disclosed apparatus generates a retrieval file representative of the chronological order of importance levels of a conference based on the chronological relationship of conference data and weighting information based on keywords and utterers, and narrows down scenes including important items to reduce the time required to generate conference minutes.

### DISCLOSURE OF THE INVENTION

According to the above method which uses a recording tape, it is difficult to find and reproduce necessary data in a limited time because the process of finding the necessary data requires reproduced speech to be confirmed while repeatedly rewinding and fast-forwarding the recording tape. The method is also disadvantageous in that when the speech data are randomly reproduced while some of the speech data are being skipped, it is impossible to grasp the relationship between the reproduced speech data.

Another problem of the method is that if some of the conference content is reproduced and judged to be important, then it is not possible to reproduce only the contents related to the important conference content, or if some of the conference content is judged to be unimportant, then it is not possible to skip the unimportant conference content when reproducing the conference content.

According to the method of producing conference minutes, even though the time required to produce conference minutes can be shortened by using the conference minute production assisting apparatus, the following shortcomings remain to be eliminated:

Since the accuracy of speech recognition according to the present technology level is low, the conference minute production assisting apparatus has not been fully automatized. It is thus difficult to convert speech data into a text and generate conference minutes from the text without human intervention. For the same reason, the content of a conference cannot be confirmed immediately after the conference is over or while the conference is in progress.

Conference minutes are descriptive only of contents that the conference minute writer judges to be important, and are not linked to the original conference data. Therefore, the user is not necessarily capable of referring to necessary information.

It is an object of the present invention to provide a speech data summarizing and reproducing apparatus, a speech data summarizing and reproducing method, and a speech data summarizing and reproducing program which are capable of arranging and reproducing important items of the content of a conference within a specific amount of time depending on the purpose and need of the user immediately after the conference is over or while the conference is in progress.

To achieve the above object, a speech data summarizing and reproducing apparatus according to the present invention comprises a speech data storage for storing speech data, a speech data divider for dividing the speech data into several utterance unit data, an importance level calculator for calculating importance levels of the respective utterance unit data based on predetermined importance level information which includes importance levels of keywords and importance levels of utterers, a summarizer for selecting the utterance unit data in descending order of importance levels thereof such that the total utterance time is kept within a predetermined amount of time, and a speech data reproducer for successively reproducing and outputting the selected utterance unit data.

The speech data summarizing and reproducing apparatus selects and summarizes important portions of speech data produced by recording a lecture, a conference, or the like such that they are arranged within a predetermined amount of time. The user can thus confirm the contents of the lecture or the conference within the predetermined amount of time.

In the above speech data summarizing and reproducing apparatus, the summarizer may have a function which selects the utterance unit data in descending order of importance levels thereof such that the total utterance time is kept within a time that is input and specified by the user.

According to the above manner, speech data produced by recording a lecture, a conference, or the like is summarized into data having an utterance time which is kept within a time that is required by the user.

The above speech data summarizing and reproducing apparatus may further comprise an importance level information determiner for determining the importance level information based on an input from the user, and the importance level calculator may have a function which calculates the importance levels of the respective utterance unit data based on the importance level information determined by the importance level information determiner.

Speech data produced by recording a lecture, a conference, or the like can thus be summarized into contents depending on the purpose and need of the user.

In the above speech data summarizing and reproducing apparatus, the speech data divider may have a function which divides the speech data at break points including when an utterer takes over and when there is a pause interval in the speech data.

Speech data produced by recording a lecture, a conference, or the like can thus be divided into several utterance unit data without the speech data being divided at some point in the sentence of the utterance.

In the above speech data summarizing and reproducing apparatus, priority levels may be set for respective type of the break points, and the speech data divider may have a function which successively selects break points in a descending order of priority levels and which divides the speech data at the selected break points such that the utterance time of each set of utterance unit data is kept within a predetermined amount of time.

The speech data can thus be divided such that the reproduction time of each of the utterance unit data is kept within a predetermined amount of time. For example, it is assumed that the reproduction time of utterance unit data is set to 30 seconds, and that the priority level of “when an utterer takes over” is set to “high”, the priority levels of “pause (silent interval) for 2 seconds or more” and “when a document page is turned over” are set to “medium”, and the priority level of “the appearance tendency of a speech recognition character string” is set to “low” for information obtained as a result of speech recognition. First, the speech data are divided at the break point “when an utterer takes over”. If the length of each of the utterance unit data is kept within 30 seconds, then the dividing process is finished. If there are utterance unit data having a length in excess of 30 seconds, then those utterance unit data are divided at the break points “pause for 2 seconds or more” and “when a document page is turned over”. In this manner, the speech data are divided such that each of all the divided utterance unit data is kept within 30 seconds.

In the above data summarizing and reproducing apparatus, the speech data reproducer may have a function which reproduces and outputs the utterance unit data selected by the summarizer in chronological order. Speech data produced by recording a lecture, a conference, or the like can thus be summarized and reproduced in a chronological order.

In the above data summarizing and reproducing apparatus, the speech data reproducer may have a function which reproduces and outputs the utterance unit data selected by the summarizer in descending order of importance levels thereof. Speech data produced by recording a lecture, a conference, or the like can thus be summarized and reproduced in descending order of importance levels.

The above data summarizing and reproducing apparatus may further comprise a text information display for displaying utterance unit data information including the utterers of utterance unit data, the utterance times thereof, and character strings of speech recognition results thereof as text information on a screen when the utterance unit data are reproduced.

The user can now easily understand the content of the speech data since the user can refer not only to the speech, but also to the text information displayed on the screen.

A speech data summarizing and reproducing method according to the present invention comprises a speech data dividing step of dividing stored speech data into several utterance unit data, an importance level calculating step of calculating importance levels of the respective utterance unit data based on predetermined importance level information which includes importance levels of keywords and importance levels of utterers, a summarizing step of selecting the utterance unit data in descending order of importance levels thereof such that the total utterance time is kept within a predetermined amount of time, and a speech data reproducing step of successively reproducing and outputting the selected utterance unit data.

The speech data summarizing and reproducing method selects and summarizes important portions of speech data produced by recording a lecture, a conference, or the like such that they are kept within a predetermined amount of time. The user can thus confirm the contents of the lecture or the conference within the predetermined time.

In the above data summarizing and reproducing method, the summarizing step may comprise a step of selecting the utterance unit data in descending order of importance levels thereof such that the total utterance time is kept within an amount of time that is input and specified by the user.

The above summarizing step can summarize speech data produced by recording a lecturer a conference, or the like into data having an utterance time kept within an amount of time that is specified by the user.

The above speech data summarizing and reproducing method may further comprise an importance level information determining step of determining the importance level information based on an input from the user, and the importance level calculating step may comprise a step of calculating importance levels of the respective utterance unit data based on the importance level information determined by the importance level information determining step.

Speech data produced by recording a lecture, a conference, or the like can thus be summarized into contents depending on the purpose and need of the user.

In the above speech data summarizing and reproducing method, the speech data dividing step may comprise a step of dividing the speech data at break points including when an utterer takes over and when there is a pause interval in the speech data.

Speech data produced by recording a lecture, a conference, or the like can thus be divided into several utterance unit data without the speech data being divided a some point in the sentence of the utterance.

In the above speech data summarizing and reproducing method, priority levels may be set for respective type of the break points, and the speech data dividing step may comprise a step of successively selecting the break points in descending order of priority levels to divide the speech data such that the utterance time of each of the utterance unit data is kept within a predetermined amount of time.

The speech data can thus be divided such that the reproduction time of each of the utterance unit data is kept within a predetermined amount of time. For example, it is assumed that the reproduction time of utterance unit data is set to 30 seconds, and that the priority level of “when an utterer takes over” is set to “high”, the priority levels of “pause (silent interval) for 2 seconds or more” and “when a document page is turned over” are set to “medium”, and the priority level of “the appearance tendency of a speech recognition character string” is set to “low” for information obtained as a result of speech recognition. First, the speech data are divided at the break point “when an utterer takes over”. If the length of each of the utterance unit data is kept within 30 seconds, then the dividing process is finished. If there are utterance unit data having a length in excess of 30 seconds, then those utterance unit data are divided at the break points “pause for 2 seconds or more” and “when a document page is turned over”. In this manner, the speech data are divided such that each of all the divided utterance unit data is kept within 30 seconds.

In the above speech data summarizing and reproducing method, the speech data reproducing step may comprise a step of reproducing and outputting the utterance unit data selected by the summarizing step in chronological order. Speech data produced by recording a lecture, a conference, or the like can thus be summarized and reproduced in chronological order.

In the above speech data summarizing and reproducing method, the speech data reproducing step may comprise a step of reproducing and outputting the utterance unit data selected by the summarizing step in descending order of importance levels thereof. Speech data produced by recording a lecture, a conference, or the like can thus be summarized and reproduced in descending order of importance levels.

The above speech data summarizing and reproducing method may further comprise a text information displaying step of displaying utterance unit data information including the utterers of utterance unit data, the utterance times thereof, and character strings of speech recognition results thereof as text information on a screen when the utterance unit data are reproduced.

The user can now easily understand the content of the speech data since the user can refer not only to the speech, but also to the text information displayed on the screen.

According to the present invention, there is also provided a speech data summarizing and reproducing program for enabling a computer to perform a speech data dividing process for dividing stored speech data into several utterance unit data, an importance level calculating process for calculating importance levels of the respective utterance unit data based on predetermined importance level information which includes importance levels of keywords and importance levels of utterers, a summarizing process for selecting the utterance unit data in descending order of importance levels thereof such that the total utterance time is kept within a predetermined amount of time, and a speech data reproducing process for successively reproducing and outputting the selected utterance unit data.

In the above speech data summarizing and reproducing program, the summarizing process may specify content of the utterance unit data such that utterance unit data are selected in descending order of importance levels thereof and such that the total utterance time is kept within an amount of time that is input and specified by the user.

The above speech data summarizing and reproducing program may enable the computer to perform an importance level information determining process for determining the importance level information based on an input from the user, and the importance level calculating process may specify content of the respective utterance unit data such that importance levels of the respective utterance unit data are calculated based on the importance level information determined by the importance level information determining process.

In the above speech data summarizing and reproducing program, the speech data dividing process may specify the content of the speech data such that the speech data is divided at break points including when an utterer takes over and when there is a pause interval in the speech data.

In the above speech data summarizing and reproducing program, priority levels may be set for the respective type of the break points, and the speech data dividing process may specify the content of the speech data such that the break points are successively selected in descending order of priority levels to divide the speech data and such that the utterance time of each of the utterance unit data is kept within a predetermined amount of time.

In the above speech data summarizing and reproducing program, the speech data reproducing process may specify content of the utterance unit data selected by the summarizing process such that the selected utterance unit data is reproduced and output in chronological order.

In the above speech data summarizing and reproducing program, the speech data reproducing process may the specify content of the utterance unit data selected by the summarizing process such that the selected utterance unit data are reproduced and output in descending order of importance levels thereof.

The above speech data summarizing and reproducing program may enable the computer to perform a text information displaying process for displaying utterance unit data information including the utterers of utterance unit data, the utterance times thereof, and character strings of speech recognition results thereof as text information on a screen when the utterance unit data are reproduced.

The speech data summarizing and reproducing program offers the same operation and advantages as with the above data summarizing and reproducing apparatus or the above data summarizing and reproducing method.

The invention arranged and worked as described above is capable of summarizing speech data such that its reproduction time is kept within a predetermined amount of time. Since the importance level information representing importance levels of keywords that appear and importance levels of utterers can be changed based on the speech data which are being reproduced, the speech data can dynamically be summarized according to the intention of the user. Furthermore, the user can easily understand the content of the reproduced speech because the speech data can be reproduced in combination with text data representative of speech recognition results and distributed documents.

### BRIEF DESCRIPTION OF THE DRAWINGS

FIG. 1 is a diagram showing the configuration of a speech data summarizing and reproducing apparatus according to a first exemplary embodiment of the present invention;

FIG. 2 is a flowchart of an operation sequence of the speech data summarizing and reproducing apparatus according to the exemplary embodiment shown in FIG. 1;

FIG. 3 is a diagram showing the configuration of a speech data summarizing and reproducing apparatus according to a second exemplary embodiment of the present invention;

FIG. 4 is a flowchart of an operation sequence of the speech data summarizing and reproducing apparatus according to the exemplary embodiment shown in FIG. 3;

FIG. 5 is a diagram showing the configuration of a speech data summarizing and reproducing apparatus according to a third exemplary embodiment of the present invention;

FIG. 6 is a flowchart of an operation sequence of the speech data summarizing and reproducing apparatus according to the exemplary embodiment shown in FIG. 5;

FIG. 7 is a diagram showing an example of speech data stored in a speech data storage;

FIG. 8 is a diagram showing an example of a speech data dividing process;

FIG. 9 is a diagram showing an example of importance level information stored in an importance level information storage;

FIG. 10 is a diagram showing importance levels of respective utterance unit data;

FIG. 11 is a diagram showing an example of a user interface of an importance level information determiner;

FIG. 12 is a diagram showing the manner in which importance level information is changed;

FIG. 13 is a diagram showing importance levels of respective utterance unit data;

FIG. 14 is a diagram showing an example of displayed text information; and

FIG. 15 is a diagram showing an example of a user interface of an importance level information determiner which utilizes text information.

### DESCRIPTION OF REFERENCE NUMERALS

1 input device
2 data processor
3 storage device
4 output device
21 speech data divider
22 importance level calculator
23 summarizer
24 speech data reproducer
25 importance level information determiner
26 text information display
31 speech data storage
32 importance level information storage

### BEST MODE FOR CARRYING OUT THE INVENTION

Exemplary embodiments of the present invention will be described below with reference to the drawings.

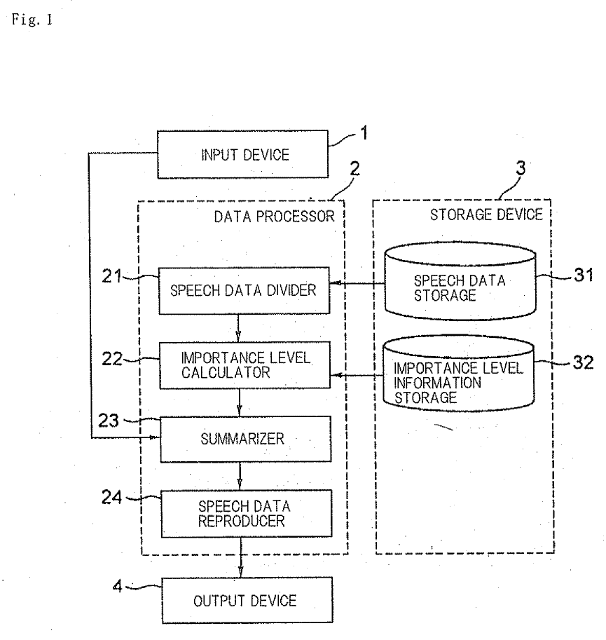

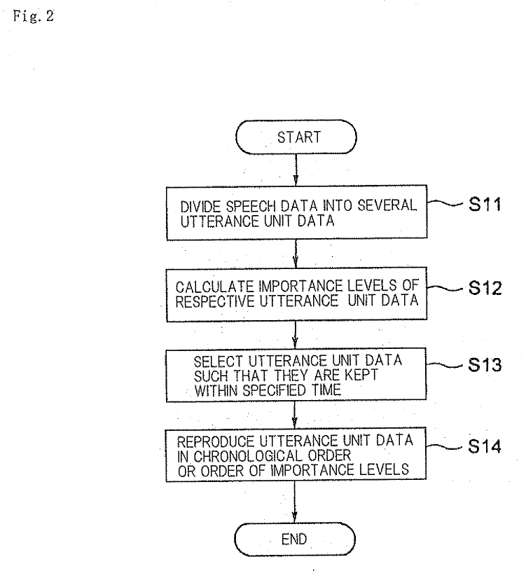

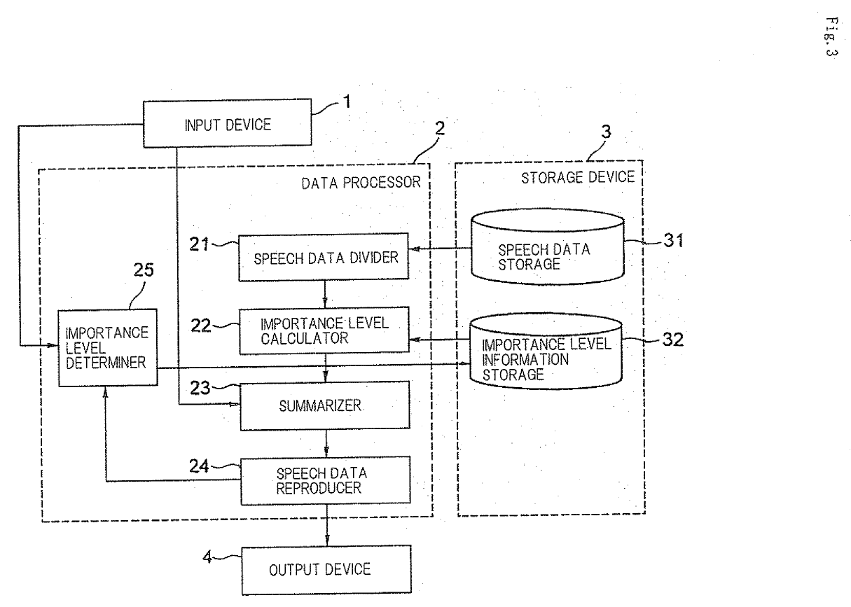

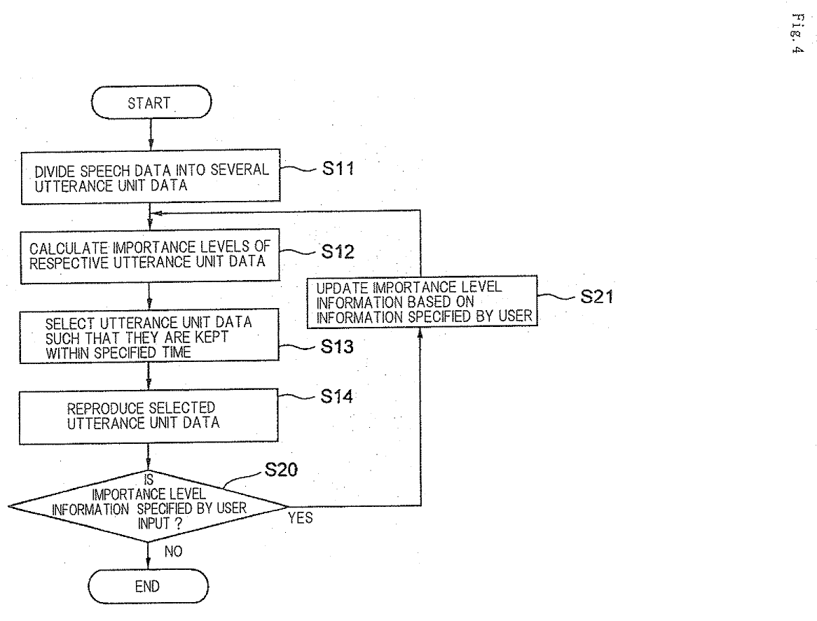

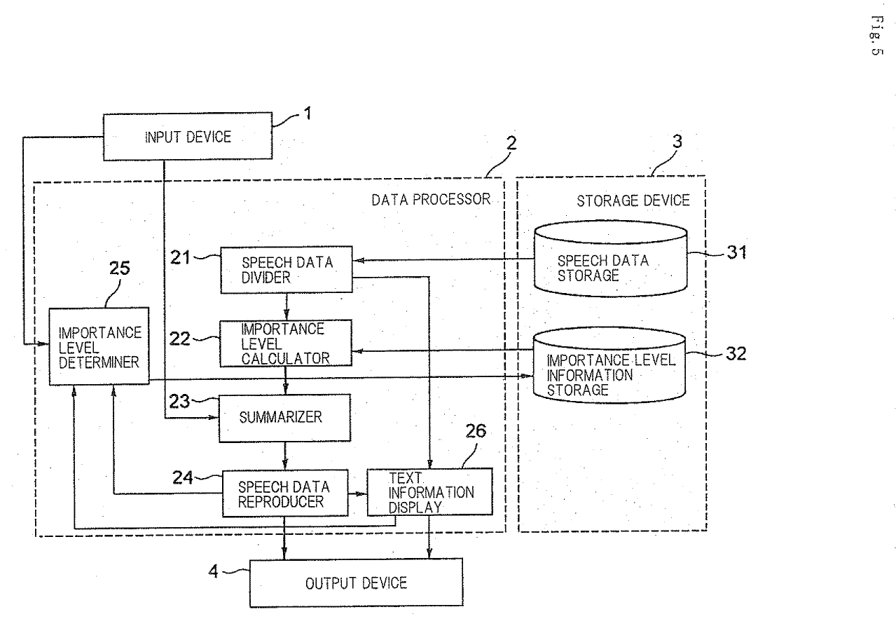

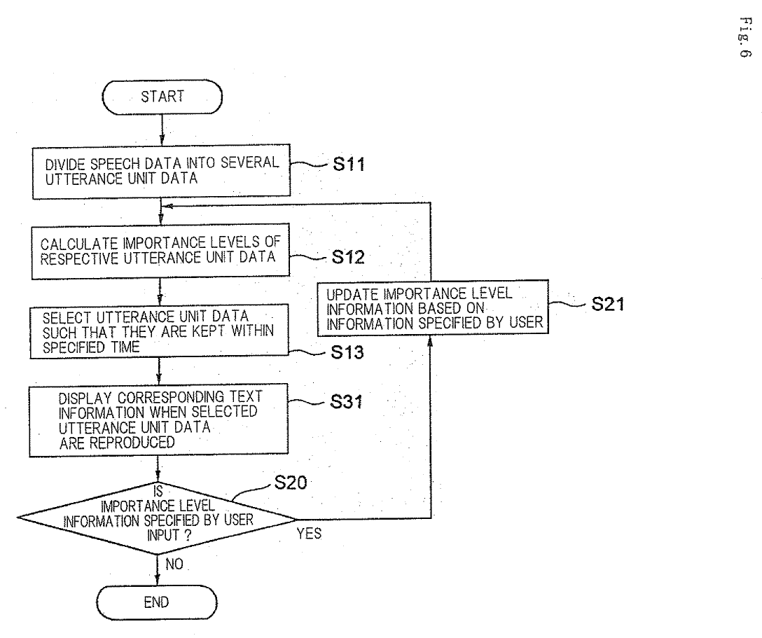

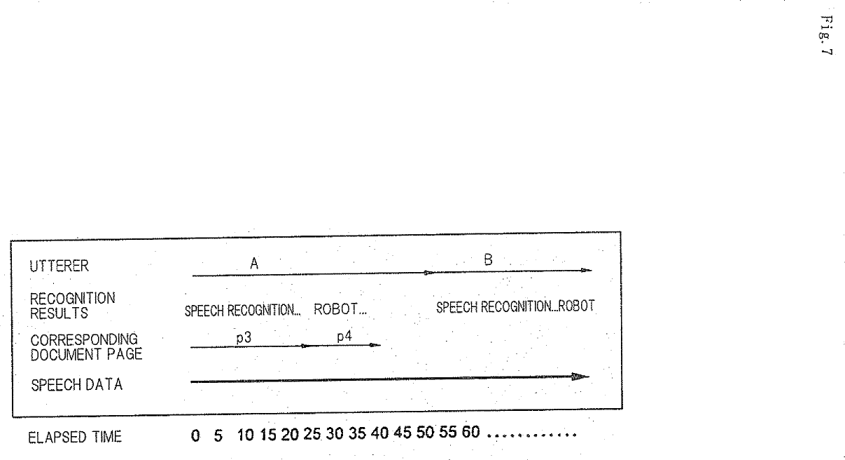

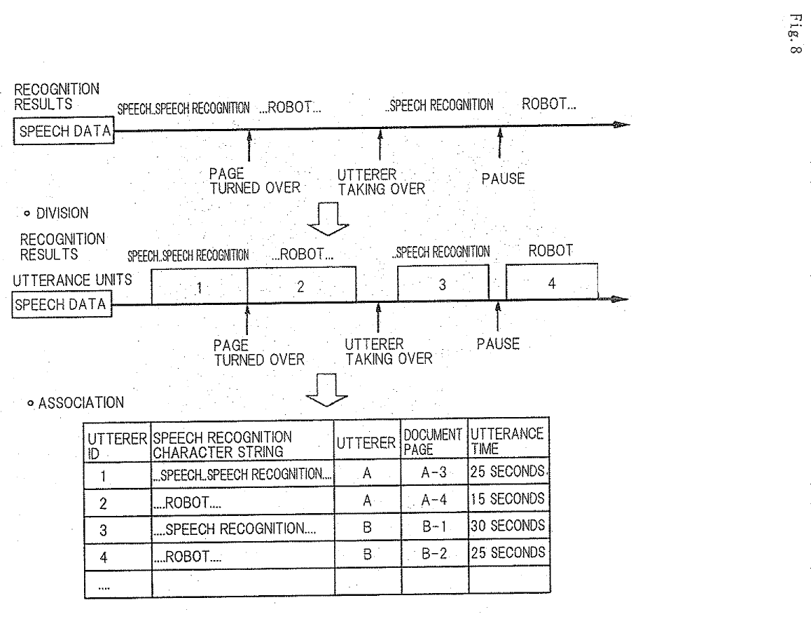

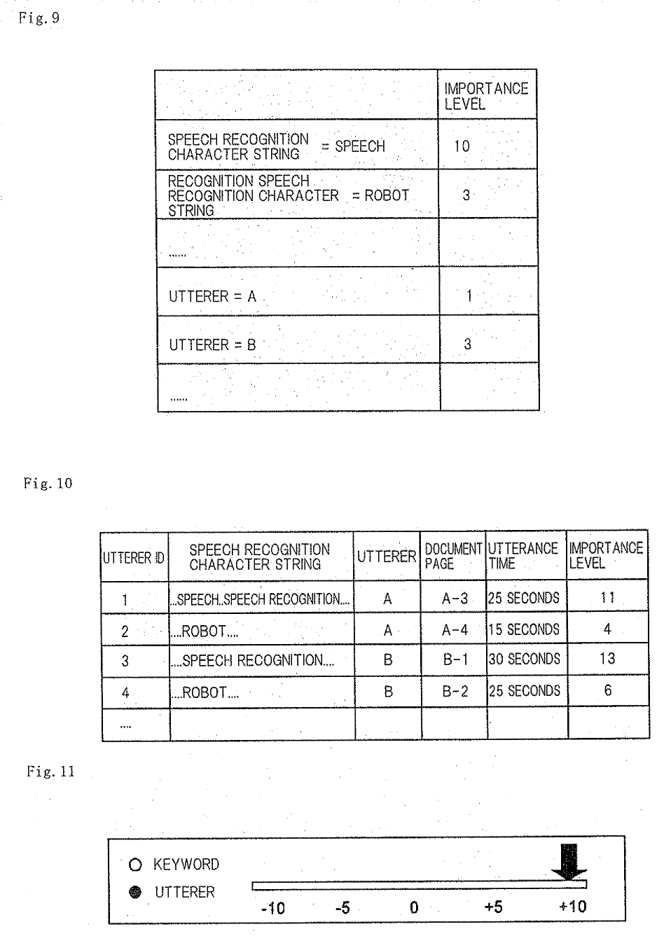

FIG. 1 is a functional block diagram showing a general scheme of the configuration of a speech data summarizing and reproducing apparatus according to a first exemplary embodiment of the present invention.

As shown in FIG. 1, the speech data summarizing and reproducing apparatus comprises input device 1 such as a keyboard or the like, data processor 2 for controlling the information processing operation of the speech data summarizing and reproducing apparatus, storage device 3 for storing various items of information, and output device 4 such as a speaker, a display, etc.

Storage device 3 comprises speech data storage 31 for storing speech data and importance level information storage 32 for storing predetermined importance level information representing importance levels based on keywords and importance levels based on utterers. Speech data storage 31 stores recorded speech data of lectures, conferences, etc., and additionally stores speech recognition results, utterer information, and information of distributed documents in association with the speech data. Importance level information storage 32 stores information representative of important keywords and important utterers.

An example of speech data stored in speech data storage 31 is illustrated in FIG. 7. As shown in FIG. 7, speech data storage 31 stores, in chronological order based on the time elapsed in a conference, speech data of the conference, utterer information, speech recognition results of the speech data, and information indicating corresponding pages of documents used in the conference.

As shown in FIG. 1, data processor 2 comprises speech data divider 21 for dividing speech data into several utterance unit data, importance level calculator 22 for calculating importance levels of the respective utterance unit data based on the importance level information stored in importance level information storage 32, summarizer 23 for selecting utterance unit data in descending order of importance levels such that the total utterance time is kept within a predetermined amount of time, and speech data reproducer 24 for successively reproducing and outputting the selected utterance unit data.

Speech data divider 21 divides speech data input from speech data storage 31 into utterance unit data. Importance level calculator 22 calculates importance levels of the utterance unit data based on the occurrence frequency of the important keywords and the information of the utterers stored in importance level information storage 32. Summarizer 23 selects utterance unit data in descending order of importance levels such that the total utterance time is kept within a time that is input to input device 1 by the user and specified thereby. Speech data reproducer 24 reproduces the utterance unit data selected by summarizer 23 in either chronological order or descending order of importance levels with connection information added to the utterance unit data.

FIG. 8 is a diagram showing an example of a speech data dividing process performed by speech data divider 21. As shown in FIG. 8, speech data divider 21 according to the present exemplary embodiment divides speech data into four utterance unit data based on information representative of break points including “when a document page is turned over”, “when an utterer takes over”, and “pause (silent interval in speech data)”, etc., and associates each of the utterance unit data with information representative of an utterance ID, a speech recognition character string, an utterer, a corresponding document page, and an utterance time.

To make it possible to reproduce utterance unit data within a specific time, speech data divider 21 divides speech data such that the time to reproduce the utterance unit data is of necessity within a certain time, e.g., 30 seconds. Speech data divider 21 sets priority levels to the types of the break points, and selects the break points in descending order of priority levels to divide the speech data.

For example, it is assumed that the priority level of the break point “when an utterer takes over” is set to “high”, the priority levels of “pause for 2 seconds or more” and “when a document page is turned over” are set to “medium”, and the priority level of “the appearance tendency of a speech recognition character string” is set to “low”. First, speech data divider 21 divides speech data at the break point “when an utterer takes over”. If the length of each of the utterance unit data is kept within 30 seconds, then speech data divider 21 finishes the dividing process. If there are utterance unit data having a length in excess of 30 seconds, then speech data divider 21 further divides those utterance unit data at the break points “pause for 2 seconds or more” and “when a document page is turned over”. According to the present exemplary embodiment, each of all the divided utterance unit data are kept within 30 seconds at this stage. Therefore, speech data divider 21 does not further divide utterance unit data at the break point “the appearance tendency of a speech recognition character string”. However, if utterance unit data having a length in excess of 30 seconds still remain undivided, then speech data divider 21 divides those utterance unit data using information representative of the appearance frequency of a words in the speech recognition character string.

FIG. 9 is a diagram showing an example of importance level information stored in importance level information storage 32. As shown in FIG. 9, the importance level information according to the present exemplary embodiment represents an importance level of 10 for the keyword “speech recognition”, an importance level of 3 for the keyword “robot”, an importance level of 1 for utterer A, and an importance level of 3 for utterer B.

Importance level calculator 22 determines the importance level of each utterance unit data by calculating the sum of corresponding items of the importance level information. For example, the utterance unit data of utterance ID1 includes a character string “speech recognition” and has utterer A. Therefore, importance level calculator 22 calculates the importance level of the utterance unit data of utterance ID1 as 10+1 11. The similarly calculated importance levels of the respective utterance unit data are shown in FIG. 10.

Summarizer 23 summarizes speech data within an utterance time specified by the user. If the user specifies 60 seconds, then summarizer 23 selects utterance unit data in descending order of importance levels such that they are kept within 60 seconds. Therefore, summarizer 23 selects, as a summarized result, the utterance unit data of utterance ID3 and the utterance unit data of utterance ID1 from the utterance unit data shown in FIG. 9.

Speech data reproducer 24 successively reproduces and outputs the utterance unit data of utterance ID3 and the utterance unit data of utterance ID1, which are selected by summarizer 23, in order of importance levels. Since the utterances are chronologically inverted at this time, connection information representing that “the utterance of previous utterer A”, for example, may be added between the utterance unit data of utterance ID3 and the utterance unit data of utterance ID1. Instead of reproducing the utterance unit data in order of importance levels, speech data reproducer 24 may keep the chronological order, and reproduce and output the utterance unit data in the order of utterance ID1 and utterance ID3.

It is thus possible to summarize and reproduce the speech data within the 60 seconds specified by the user.

Operation of the speech data summarizing and reproducing apparatus according to the present exemplary embodiment will be described below. A speech data summarizing and reproducing method according to the present invention will also be described below.

FIG. 2 is a flowchart of an operation sequence of the speech data summarizing and reproducing apparatus according to the present exemplary embodiment.

First, speech data divider 21 reads speech data from speech data storage 31, and divides the speech data into several utterance unit data at break points indicated by pause information, speech recognition results, etc. (FIG. 2: step S11, speech data dividing step). Then, importance level calculator 22 calculates and allocates importance levels of the respective utterance unit data based on the importance level information stored in importance level information storage 32 (FIG. 2: step S12, importance level calculating step).

Summarizer 23 selects utterance unit data in descending order of importance levels such that the total utterance time is kept within a time that is input to input device 1 by the user and specified thereby (FIG. 2: step S13, speech data summarizing step). Then, speech data reproducer 24 reproduces the selected utterance unit data in either chronological order or order of importance levels, and sends the reproduced utterance unit data to the output device (FIG. 2: step S14, speech data reproducing step).

The speech data dividing step, the importance level calculating step, the speech data summarizing step, and the speech data reproducing step may have their content converted into a program, and the program may be executed by a computer for controlling the speech data summarizing and reproducing apparatus to perform those steps as a speech data dividing process, an importance level calculating process, a summarizing process, and a speech data reproducing process.

### 2nd Exemplary Embodiment

A second exemplary embodiment of the present invention will be described below. FIG. 3 is a functional block diagram showing a general scheme of the configuration of a speech data summarizing and reproducing apparatus according to a second exemplary embodiment of the present invention.

As shown in FIG. 3, the speech data summarizing and reproducing apparatus according to the second exemplary embodiment has, in addition to the configuration of the speech data summarizing and reproducing apparatus according to the first exemplary embodiment, importance level information determiner 25, included in data processor 2, for determining importance level information based on data input to input device 1 by the user.

Importance level information determiner 25 according to the present exemplary embodiment updates the importance level information in importance level information storage 32 based on a keyword and an utterer's importance level that are specified by the user for an utterance which is being reproduced at present.

According to the present exemplary embodiment, speech data reproducer 24 reproduces and outputs the utterance unit data of utterance ID3 shown in FIG. 10 according to the same process as with the first exemplary embodiment described above. Description will be given of an example in which importance level information determiner 25 changes importance level information based on an input from the user.

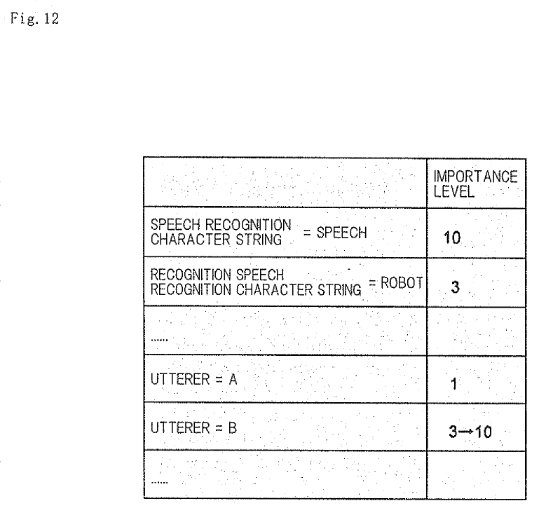

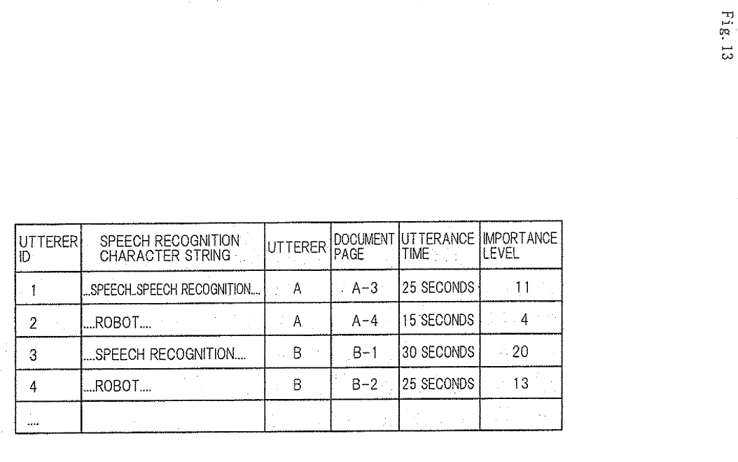

FIG. 11 shows an example of a user interface of importance level information determiner 25. According to the present exemplary embodiment, the user operates input device 1 to change the importance level of a specified utterer to +10. Then, as shown in FIG. 12, importance level information determiner 25 changes the importance level of “utterer=B” of the importance level information stored in importance level information storage 32, from 3 to 10.

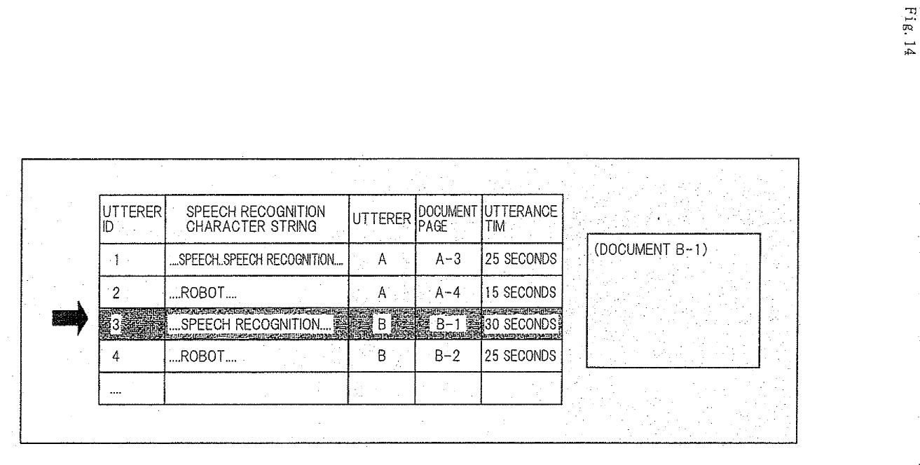

Importance level calculator 22 recalculates the importance levels of the respective utterance unit data. The recalculated results are shown in FIG. 13. Since the importance level of “utterer=B” is changed, the importance level of the utterance unit data of “utterer=B” is changed.

According to the present exemplary embodiment, if the user specifies 60 seconds, then summarizer 23 selects utterance unit data in descending order of importance levels such that they are kept within 60 seconds. Therefore, summarizer 23 selects, as a summarized result, the utterance unit data of utterance ID3 and the utterance unit data of utterance ID4. Speech data reproducer 24 skips utterance ID3 already reproduced from the utterance unit data of utterances ID3, ID4 selected by summarizer 23, and reproduces and outputs utterance ID4.

If the user changes the importance level of the keyword to −10 using the interface shown in FIG. 11 while the utterance unit data of utterance ID3 are being reproduced, then the importance level of utterance unit data which include “speech recognition” is lowered as a result of the recalculation of the importance levels, and utterance unit data which do not include “speech recognition” are preferentially reproduced.

With an importance level being thus corrected by the user, utterances which represent the preference of the user are dynamically narrowed down, making it possible to summarize and reproduce important utterances successively while the user is listening to the conference speech. Although the interface shown in FIG. 11 allows importance levels to be corrected for each of the keyword and the utterer, there may be used an interface for increasing the importance levels of the keyword and the utterer with respect to an utterance when a single button is pressed, and for reducing the importance levels of the keyword and the utterer with respect to the utterance when the button is not pressed. Such an interface makes it possible to narrow down the importance levels with a single button.

Operation of the speech data summarizing and reproducing apparatus according to the present exemplary embodiment will be described below. A speech data summarizing and reproducing method according to the present invention will also be described below.

FIG. 4 is a flowchart of an operation sequence of the speech data summarizing and reproducing apparatus according to the present exemplary embodiment.

Steps S11 through S14 shown in FIG. 4 are the same as those of the first exemplary embodiment. When the user operates input device 1 to specify importance level information, importance level information determiner 25 corrects the importance levels of the keyword and the utterer information, etc. in the utterance, and updates the importance level information in importance level information storage 32 (FIG. 4: step S21, importance level information determining step). Importance level calculator 23 calculates importance levels of the utterance unit data based on the importance level information determined by importance level information determiner 25. Thereafter, step S12, step S13, and step S14 are repeated.

The importance level information determining step may have its contents converted into a program, and the program may be executed by a computer for controlling the speech data summarizing and reproducing apparatus to perform the step as an importance level information determining process.

### 3rd Exemplary Embodiment

A third exemplary embodiment of the present invention will be described below. FIG. 5 is a functional block diagram showing a general scheme of the configuration of a speech data summarizing and reproducing apparatus according to a third exemplary embodiment of the present invention.

As shown in FIG. 5, the speech data summarizing and reproducing apparatus according to the third exemplary embodiment has, in addition to the configuration of the speech data summarizing and reproducing apparatus according to the second exemplary embodiment, text information display 26 for displaying utterance unit data information, such as the utterers of utterance unit data, the utterance times thereof, character strings of speech recognition results thereof, and distributed documents, as text information on a screen when the utterance unit data are reproduced.

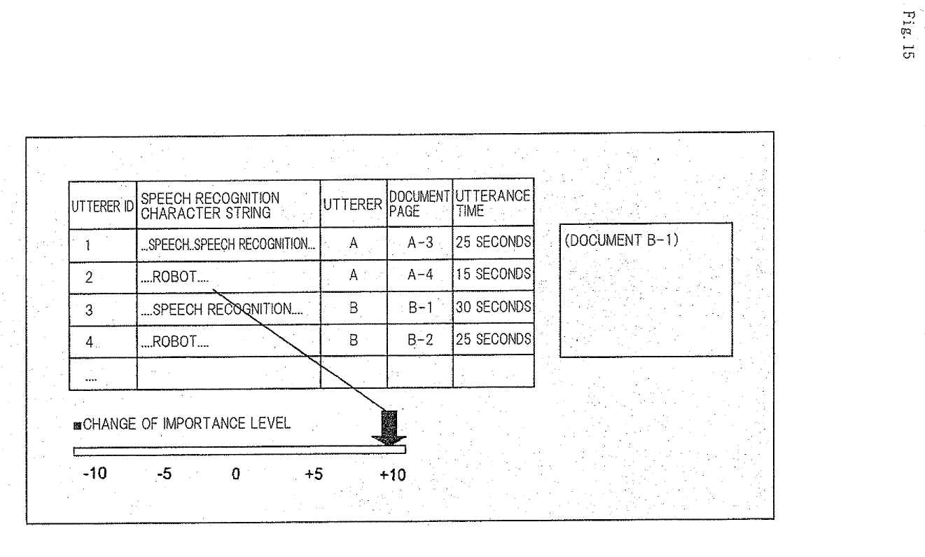

According to the present exemplary embodiment, when speech data reproducer 24 outputs summarized data according to the same process as with the first exemplary embodiment, text information display 26 displays corresponding text information on the display of output device 4 together with the reproduced speech. FIG. 14 shows an example of the display which displays the text information. FIG. 14 shows the screen on which the utterance unit data of utterance ID3 are being reproduced according to the present exemplary embodiment, the screen displaying a character string of speech recognition results and documents used.

FIG. 15 is an example of a user interface of importance level information determiner 25 which uses text information. As shown in FIG. 15, “robot” is selected in the text information, and the importance level of “robot” is changed to 10.

The user is now able to use not only the speech data, but also the text data displayed on the screen, and can easily understand the content of the conference.

Operation of the speech data summarizing and reproducing apparatus according to the present exemplary embodiment will be described below. A speech data summarizing and reproducing method according to the present invention will also be described below. FIG. 6 is a flowchart of an operation sequence of the speech data summarizing and reproducing apparatus according to the present exemplary embodiment.

Steps S11 through S13 shown in FIG. 6 are the same as those of the first exemplary embodiment. Text information display 25 sends text information corresponding to the speech data to the output device, which displays the text information on its display (FIG. 6: step S31, text information displaying step). When the user specifies a certain utterance as important or directly specifies certain locations, such as an utterer and a keyword, in the text information, importance level information determiner 25 corrects the importance level of the specified keyword and the utterer information, and updates the importance level information stored in importance level information storage 32 (FIG. 4: step S21, importance level information determining step).

The importance level information determining step and the text information displaying step may have its contents converted into a program, and the program may be executed by a computer for controlling the speech data summarizing and reproducing apparatus to perform those steps as an importance level information determining process and a text information displaying process.

### INDUSTRIAL APPLICABILITY

The present invention is applicable to a speech reproducing apparatus for summarizing and reproducing speech from a speech database, and is applicable to a program for implementing a speech reproducing apparatus with a computer. The present invention is also applicable to a TV• WEB conference apparatus having a function to reproduce speech, and to a program for implementing a TV• WEB conference apparatus with a computer.

1. A speech data summarizing and reproducing apparatus comprising:
a speech data storing means for storing speech data;
a speech data dividing means for dividing the speech data into several utterance unit data;
an importance level calculating means for calculating importance levels of the respective utterance unit data based on predetermined importance level information which includes importance levels of keywords and importance levels of utterers;
a summarizing means for selecting the utterance unit data in descending order of importance levels thereof such that the total utterance time is kept within a predetermined amount of time; and
a speech data reproducing means for successively reproducing and outputting the selected utterance unit data.

2. The speech data summarizing and reproducing apparatus according to claim 1, wherein said summarizing means has a function which selects said utterance unit data in descending order of importance levels there of such that the total utterance time is kept within a time that is input and specified by the user.

3. The speech data summarizing and reproducing apparatus according to claim 1, further comprising:
an importance level information determining means for determining said importance level information based on an input from the user;
wherein said importance level calculating means has a function which calculates importance levels of the respective utterance unit data based on the importance level information determined by said importance level information determining means.

4. The speech data summarizing and reproducing apparatus according to claim 1, wherein said speech data dividing means has a function which divides said speech data at break points including when an utterer takes over and when there is a pause interval in said speech data.

5. The speech data summarizing and reproducing apparatus according to claim 4, wherein priority levels are set for respective type of said break points, and said speech data dividing means has a function which successively selects break points in descending order of priority levels to divide said speech data such that the utterance time of each of the utterance unit data is kept within a predetermined amount of time.

6. The speech data summarizing and reproducing apparatus according to claim 1, wherein said speech data reproducing means has a function which reproduces and outputs the utterance unit data selected by said summarizing means in chronological order.

7. The speech data summarizing and reproducing apparatus according to claim 1, wherein said speech data reproducing means has a function which reproduces and outputs the utterance unit data selected by said summarizing means in descending order of importance levels thereof.

8. The speech data summarizing and reproducing apparatus according to claim 1, further comprising:
a text information displaying means for displaying utterance unit data information including the utterers of utterance unit data, the utterance times thereof, and character strings of speech recognition results thereof as text information on a screen when the utterance unit data are reproduced.

9. A speech data summarizing and reproducing method comprising:
dividing stored speech data into several utterance unit data;
calculating importance levels of respective utterance unit data based on predetermined importance level information which includes importance levels of keywords and importance levels of utterers;
of selecting the utterance unit data in descending order of importance levels thereof such that the total utterance time is kept within a predetermined amount of time; and
successively reproducing and outputting the selected utterance unit data.

10. The speech data summarizing and reproducing method according to claim 9, wherein said utterance unit data selecting step comprises a step of selecting said utterance unit data in descending order of importance levels thereof such that the total utterance time is kept within a time that is input and specified by the user.

11. The speech data summarizing and reproducing method according to claim 9, further comprising:
determining said importance level information based on an input from the user;
wherein said importance level calculating step includes a step of calculating importance levels of respective utterance unit data based on importance level information determined by said importance level information determining step.

12. The speech data summarizing and reproducing method according to claim 9, wherein said speech data dividing step includes a step of dividing said speech data at break points including when an utterer takes over and when there is a pause interval in said speech data.

13. The speech data summarizing and reproducing method according to claim 12, wherein priority levels are set for respective type of said break points, and said speech data dividing step comprises includes a step of successively selecting the break points in descending order of priority levels to divide said speech data such that the utterance time of each of the utterance unit data is kept within a predetermined amount of time.

14. The speech data summarizing and reproducing method according to claim 9, wherein said speech data reproducing step includes a step of reproducing and outputting the utterance unit data selected by said summarizing step in chronological order.

15. The speech data summarizing and reproducing method according to claim 9, wherein said speech data reproducing step includes a step of reproducing and outputting the utterance unit data selected by said summarizing step in descending order of importance levels thereof.

16. The speech data summarizing and reproducing method according to claim 9, further comprising:
displaying utterance unit data information including the utterers of utterance unit data, the utterance times thereof, and character strings of speech recognition results thereof as text information on a screen when the utterance unit data are reproduced.

17. A recording medium recorded with a speech data summarizing and reproducing program, said program being for causing a computer to execute:
a speech data dividing process for dividing stored speech data into several utterance unit data;
an importance level calculating process for calculating importance levels of respective utterance unit data based on predetermined importance level information which includes importance levels of keywords and importance levels of utterers;
a summarizing process for selecting the utterance unit data in descending order of importance levels thereof such that the total utterance time is kept within a predetermined amount of time; and
a speech data reproducing process for successively reproducing and outputting the selected utterance unit data.

18. The recording medium according to claim 17, wherein said summarizing process comprises a process for specifying the content of said utterance unit data such that said utterance unit data is selected in descending order of importance levels thereof and such that the total utterance time is kept within a time that is input and specified by the user.

19. The recoding medium according to claim 17, wherein said program causes the computer to further execute a process for enabling the computer to perform an importance level information determining process for determining said importance level information based on an input from the user, and said importance level calculating process comprises a process for specifying the content of respective utterance unit data such that importance levels of respective utterance unit data are calculated based on the importance level information determined by said importance level information determining process.

20. The recoding medium according to claim 17, wherein said speech data dividing process comprises a process for specifying the content of said speech data such that said speech data is divided at break points including when an utterer takes over and when there is a pause interval in said speech data.

21. The recording medium according to claim 20, wherein priority levels are set for the respective type of said break points, and said speech data dividing process comprises a process for specifying the content of said speech data such that said break points are successively selected in descending order of priority levels to divide said speech data and such that the utterance time of each of the utterance unit data is kept within a predetermined amount of time.

22. The recording medium according to claim 17, wherein said speech data reproducing process comprises a process for specifying the content of the utterance unit data selected by said summarizing such that the selected utterance unit data is reproduced and output in a chronological order.

23. The recording medium according to claim 17, wherein said speech data reproducing process comprises a process for specifying the content of the utterance unit data selected by said summarizing process such that the selected utterance unit data is reproduced and output in descending order of importance levels thereof.

24. The recording medium according to claim 17, wherein said program causes the computer to further execute a process for enabling the computer to perform a text information displaying process for displaying utterance unit data information including the utterers of utterance unit data, the utterance times thereof and character strings of speech recognition results thereof as text information on a screen when the utterance unit data are reproduced.

25. A speech data summarizing and reproducing apparatus comprising:
a speech data storage unit which stores speech data;
a speech data divider which divides the speech data into several utterance unit data;
an importance level calculator which calculates importance levels of the respective utterance unit data based on predetermined importance level information which includes importance levels of keywords and importance levels of utterers;
a summarizer which selects the utterance unit data in descending order of importance levels thereof such that the total utterance time is kept within a predetermined amount of time; and
a speech data reproducer which successively reproduces and outputs the selected utterance unit data.
